(19) United States
(12) Patent Application Publication
(10) Pub. No.: US 2010/0105514 A1
(43) Pub. Date: Apr. 29, 2010

(54) Drive Assembly having ring gear friction clutch

(75) Inventors: Matthew William Dames, Brimfield, IL (US); Satish Dattatraya Savant, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/289,434

(22) Filed: Oct. 28, 2008

(51) Int. Cl. F16H 57/10

(52) U.S. Cl. 475/257

(57) ABSTRACT

A drive assembly for use with a mobile machine is disclosed. The drive assembly may have a flywheel, a planet carrier having a plurality of planet gears, and a damper operatively connecting the flywheel to the planet carrier. The drive assembly may also have a sun gear configured to mesh with the plurality of planet gears, a ring gear configured to mesh with the plurality of planet gears, and a friction clutch configured to inhibit rotation of the ring gear when a torque of the drive assembly is less than a threshold value.

### TECHNICAL FIELD

The present disclosure is directed to a drive assembly and, more particularly, to a drive assembly having a ring gear friction clutch.

### BACKGROUND

Mobile machines, including dozers, on- and off-highway haul and vocational trucks, wheel loaders, motor graders, and other types of heavy equipment generally include a prime mover drivingly coupled to opposing traction devices by way of a transmission, for example an electric transmission having a generator and one or more motors. The generator receives a power input from the prime mover and produces electricity directed to drive the motors. A reduction mechanism, for example a planetary gear arrangement, is commonly disposed between the engine and the generator to facilitate the transfer of power from the prime mover to the generator.

In some situations, it may be possible for the power transferred between the prime mover and the generator to exceed a desired amount. To help minimize damage to the engine or generator during these situations, the reduction mechanism can include an overload clutch. The overload clutch is configured to allow the transfer of torque between the prime mover and the generator when the torque is less than the desired amount. And, when the torque exceeds the desired amount, the overload clutch is configured to slip and thereby reduce the torque transmission.

An example of a drive assembly having an overload clutch is disclosed in U.S. Pat. No. 5,846,153 (the '153 patent) issued to Matsuoka on Dec. 8, 1998. Specifically, the '153 patent discloses a clutch mechanism disposed between an engine and a transmission. The clutch mechanism includes a flywheel connected to a crankshaft of and supplied with torque from the engine, an output shaft of the transmission, a planetary gear train, and a hydraulically operated clutch. The planetary gear train has a sun gear, a carrier supporting planet gears meshing with the sun gear, and a ring gear meshing with the planet gears. The flywheel is connected to rotate the sun gear by way of a damper device. The clutch is hydraulically operable to selectively hold stationary the ring gear or allow the ring gear to rotate, thereby limiting a torque transfer from the engine to the transmission.

Although the clutch apparatus described in the '153 patent may help limit torque transmission, it may be complex, expensive, and unreliable. In particular, because the clutch is selectively and hydraulically operable, it may require complex flow control mechanisms, which can increase a cost of the system. In addition, the complex flow control mechanisms reduce a reliability of the system and increase the likelihood of improper operation.

The drive assembly of the present disclosure solves one or more of the problems set forth above and/or other problems of the prior art.

### SUMMARY

One aspect of the present disclosure is directed to a drive assembly. The drive assembly may include a flywheel, a planet carrier having a plurality of planet gears, and a damper operatively connecting the flywheel to the planet carrier. The drive assembly may also include a sun gear configured to mesh with the plurality of planet gears, a ring gear configured to mesh with the plurality of planet gears, and a friction clutch configured to inhibit rotation of the ring gear when a torque of the drive assembly is less than a threshold value.

Another aspect of the present disclosure is directed to a method of transmitting power. The method may include rotating a mass with an engine, transferring energy from the mass to rotate a first mechanism, and damping torsional oscillations between the mass and the first mechanism. The method may also include transferring energy from the first mechanism to a second mechanism that drives a generator, and inhibiting a third mechanism from being rotated by the first mechanism when a torque of the first mechanism is less then a threshold value.

### BRIEF DESCRIPTION OF THE DRAWINGS

FIG. 1 is a pictorial illustration of an exemplary disclosed power system; and

FIG. 2 is a cross-sectional illustration of an exemplary disclosed drive assembly that may be used with the power system of FIG. 1.

### DETAILED DESCRIPTION

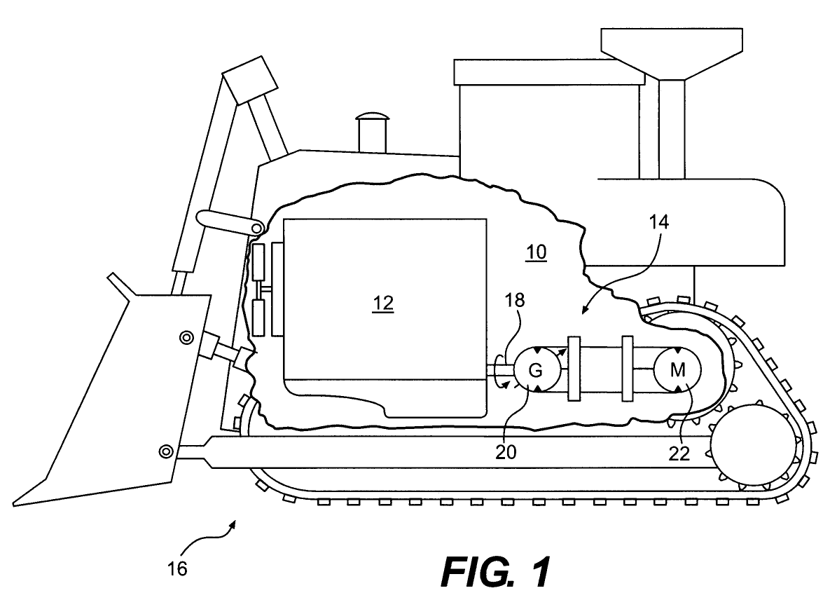

FIG. 1 illustrates an exemplary power system 10 having a power source 12 that provides mechanical input to a drive assembly 14. In one embodiment, power system 10 may form a portion of a mobile machine 16 such as, for example, a dozer, a haul truck, an excavator, or any other mobile machine known in the art, with drive assembly 14 functioning as the propulsion unit of machine 16. Drive assembly 14 may additionally or alternatively function as an auxiliary power-generating unit of machine 16, if desired. It is contemplated that power system 10 may alternatively form a portion of a stationary machine such as a generator set, a pump, or any other suitable stationary machine.

Power source 12 may include a combustion engine configured to produce a rotational mechanical power output directed to drive assembly 14. For example, power source 12 may include a diesel engine, a gasoline engine, a gaseous fuel-powered engine, or any other type of combustion engine apparent to one skilled in the art. It is also contemplated that power source 12 may alternatively embody a non-combustion source of power such as a fuel cell or a battery, if desired. Power source 12 may be rotatably connected to drive assembly 14 by way of a crankshaft 18.

Drive assembly 14 may embody an electric transmission generally consisting of a driving element and one or more driven elements. In one example, the driving element may be a generator 20, and the driven element may be an electric motor 22 powered by generator 20.

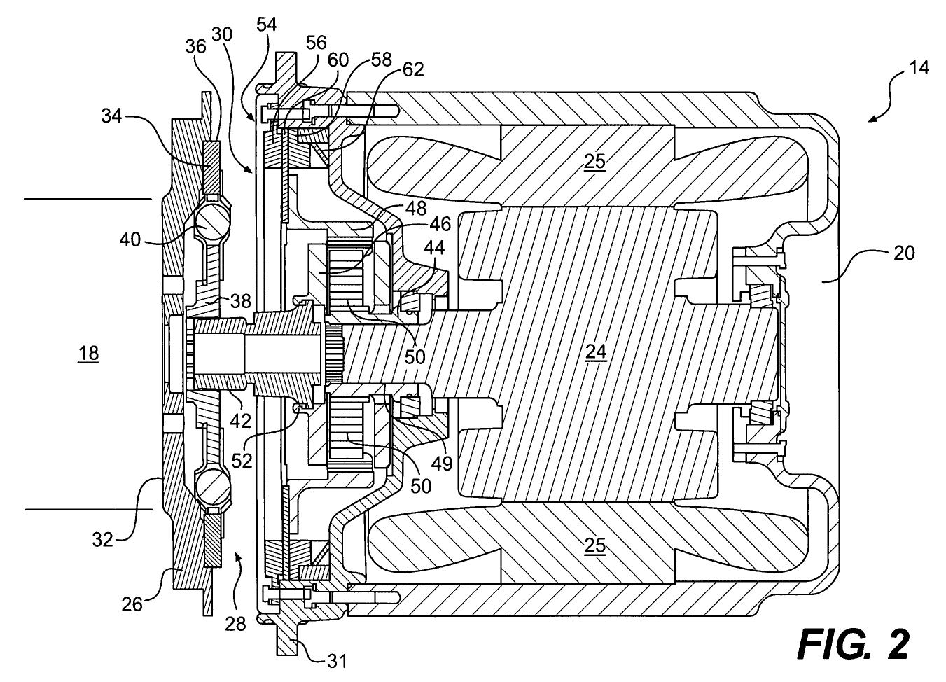

Generator 20 may be a three-phase, permanent magnet, alternating field-type generator configured to produce a power output in response to a rotational input from power source 12. It is contemplated, however, that generator 20 may alternatively be a switched reluctance generator, a direct phase generator, or any other appropriate type of generator known in the art. As shown in FIG. 2, generator 20 may include a rotor 24 operatively driven by crankshaft 18 to rotate within a stator 25 and produce electrical power directed to motor 22 (referring to FIG. 1).

Rotor 24 may be connected to crankshaft 18 by way of a flywheel 26, a damper 28, and a planetary gear arrangement 30. Specifically, flywheel 26 may be centrally and rigidly connected to an end of crankshaft 18 by way of threaded fastening (not shown). Damper 28 may be connected at an outer periphery to flywheel 26, and at an inner periphery to planetary gear arrangement 30. Planetary gear arrangement 30 may have an input connected to damper 28, and an output connected to rotor 24. A housing 31 may at least partially enclose one or more of flywheel 26, damper 28, and planetary gear arrangement 30.

Flywheel 26 may be any type of device useful for storing and releasing rotational energy to dampen transient loads placed on or exerted by power system 10. For example, flywheel 26 may be a fixed inertia flywheel, a variable inertia flywheel, an electric flywheel, or any other type of flywheel known in the art. Flywheel 26 may include a general ring-like mass having a first mounting surface 32 that connects with the end of crankshaft 18, and a second opposing mounting surface 34 that connects with damper 28.

Damper 28 may include multiple components that interact to dampen torsional oscillations between flywheel 26 and planetary gear arrangement 30. In particular, damper 28 may include a drive plate 36, a driven plate 38, and at least one elastic member 40, for example a torsional spring or flex plate, disposed between and coupling drive and driven plates 36, 38. Drive plate 36 may be operatively connected to flywheel 26, while driven plate 38 may be operatively connected to planetary gear arrangement 30 by way of a hub 42. Hub 42 may include, in one example, external splines that are received by internal splines of driven plate 38. In this manner, hub 42 and planetary gear arrangement 30 may be allowed to move axially relative to damper 28 and flywheel 26 during operation of power system 10.

For the purposes of this disclosure, a planetary gear arrangement may have at least three mechanisms, including a sun gear, a planet carrier having at least one set of connected planet gears, and a ring gear. The planet gears of the planet carrier may mesh with the sun gear and the ring gear, and with intermediate planet gears of the same planet carrier, if intermediate planet gears are included in the planetary gear arrangement. The sun gear, planet carrier, planet gears, and ring gear may all rotate together simultaneously. Alternatively, one or more of the sun gear, planet carrier, and ring gear may be held stationary or caused to move at a modified speed to thereby alter a reduction ratio of the arrangement. The planetary gear arrangement may receive one or more input rotations and generate one or more corresponding output rotations. The change in rotational speed between the inputs and the outputs may be known as a reduction ratio and be dependent upon the number of teeth in the sun gear and the ring gear. The change in rotational speed may also depend upon the gear(s) that is used to receive the input rotation, the gear(s) that is selected to provide the output rotation, and which gear, if any, is held stationary or speed modified.

In the exemplary embodiment of FIG. 2, planetary gear arrangement 30 may include a sun gear 44, a planet carrier 46, and a ring gear 48. Sun gear 44 may be connected via a splined engagement 49 to drive rotor 24 of generator 20. A plurality of planet gears 50 may be connected to rotate with planet carrier 46 and to mesh with both sun gear 44 and ring gear 48. Planet carrier 46 may be rotationally driven by hub 42 via a splined engagement 52. Thus, the motion and power provided to hub 42 may be transmitted through planetary gear arrangement 30 to rotor 24 of generator 20 via planet carrier 46, planet gears 50, and sun gear 48, with ring gear 48 only affecting a reduction ratio of the motion.

Ring gear 48 may rotate or be held stationary to affect the reduction ratio of planetary gear arrangement 30. Specifically, a clutch 54 may be positioned to inhibit the motion of ring gear 48 when a torque passing through drive assembly 14 (i.e., when a torque passing from hub 42 to rotor 24) is less than a threshold value. And, when the torque passing through drive assembly 14 is greater than the threshold value, ring gear 48 may be allowed to slip and rotate with respect to clutch 54. The rotation of ring gear 48 may act to reduce a magnitude of the torque transmitted via planetary gear arrangement 30 and, thereby, lower a likelihood of damage to components of power system 10.

In one example, clutch 54 may be a friction-type clutch disposed radially outward of ring gear 48 to lock ring gear 48 to housing 31 when the torque passing through drive assembly 14 is low (i.e., when the torque is less than the threshold value). In particular, clutch 54 may include a reaction plate 56, a pressure plate 58, a friction plate 60 sandwiched between reaction and pressure plates 56, 58, and a biaser 62, for example a spring or a Bellville washer, that urges pressure plate 58 toward reaction plate 56. Reaction plate 56 and pressure plate 58 may both be connected to and supported by housing 31, while friction plate 60 may be rotationally fixed to rotate with and be supported by ring gear 48. In this arrangement, biaser 62, via reaction and pressure plates 56, 58, may generate and apply a pressure on friction plate 60 that retards the motion of ring gear 48. And, when the torque passing through drive assembly 14 is below the threshold value, the pressure caused by biaser 62 may be sufficient to stop and/or maintain ring gear 48 substantially stationary.

### INDUSTRIAL APPLICABILITY

The drive assembly of the present disclosure may be applicable to any power system where excessive torques could be damaging. The disclosed drive assembly may help limit a maximum torque transmission by providing a simple friction clutch that allows a portion of a planetary gear arrangement to slip in response to excessive torques. The slipping of a ring gear of the planetary arrangement may help reduce an amount of torque passing through the planetary gear arrangement.

Because the disclosed drive assembly may utilize a simple friction clutch to control torque levels, the assembly may be relatively inexpensive and reliable. That is, few, if any, control mechanisms may be required to facilitate the disclosed torque limiting. And the reduced number of components may help lower the cost of the assembly while promoting reliable operation.

It will be apparent to those skilled in the art that various modifications and variations can be made to the drive assembly of the present disclosure without departing from the scope of the disclosure. Other embodiments will be apparent to those skilled in the art from consideration of the specification and practice of the drivetrain disclosed herein. It is intended that the specification and examples be considered as exemplary only, with a true scope of the disclosure being indicated by the following claims and their equivalents.

What is claimed is:

1. A drive assembly, comprising:
a flywheel;
a planet carrier having a plurality of planet gears;
a damper operatively connecting the flywheel to the planet carrier;
a sun gear configured to mesh with the plurality of planet gears;
a ring gear configured to mesh with the plurality of planet gears; and
a friction clutch configured to inhibit rotation of the ring gear when a torque of the drive assembly is less than a threshold value.

2. The drive assembly of claim 1, wherein the friction clutch is further configured to allow rotation of the ring gear when the torque of the drive assembly is greater than the threshold value.

3. The drive assembly of claim 1, wherein allowing rotation of the ring gear reduces an amount of torque transmitted by the drive assembly.

4. The drive assembly of claim 1, further including a generator rotor operatively connected to and driven by the sun gear.

5. The drive assembly of claim 1, further including an engine crankshaft cooperatively connected to drive the flywheel.

6. The drive assembly of claim 1, wherein the damper includes at least one torsional spring.

7. The drive assembly of claim 1, furthering including a housing configured to at least partially enclose the flywheel, the planet carrier, the damper, the sun gear, the ring gear, and the friction clutch, wherein the friction clutch is configured to inhibit rotation of the ring gear by locking the ring gear to the housing.

8. The drive assembly of claim 7, wherein the friction clutch is radially located between the housing and the ring gear.

9. The drive assembly of claim 1, wherein the friction clutch includes a reaction plate, a pressure plate, a friction plate located between the reaction and pressure plates, and a biaser configured to urge the pressure plate toward the reaction plate.

10. The drive assembly of claim 9, wherein the friction plate is rotationally fixed to the ring gear.

11. The drive assembly of claim 1, further including a hub operatively connecting the damper to the planet carrier.

12. A method of transmitting power, comprising:
rotating a mass with an engine;
transferring energy from the mass to rotate a first mechanism;
damping torsional oscillations between the mass and the first mechanism;
transferring energy from the first mechanism to a second mechanism that drives a generator; and
inhibiting a third mechanism from being rotated by the first mechanism when a torque of the first mechanism is less then a threshold value.

13. The method of claim 12, further including allowing the third mechanism to be rotated by the first mechanism when a torque transmitted from the engine to the generator is greater than the threshold value.

14. The method of claim 13, wherein allowing the third mechanism to be rotated reduces the torque transmitted from the engine to the generator.

15. The method of claim 13, wherein inhibiting the third mechanism from being rotated includes applying a retarding force to the third mechanism with opposing plates.

16. The method of claim 13, wherein inhibiting the third mechanism from being rotated includes locking the third mechanism to a stationary housing.

17. The method of claim 13, further including allowing the mass to move axially relative to the first mechanism.

18. A power system, comprising:
an engine;
a flywheel operatively driven by the engine;
a planet carrier having a plurality of planet gears;
a damper operatively connecting the flywheel to the planet carrier;
a generator;
a sun gear configured to mesh with the plurality of planet gears and to drive the generator;
a ring gear configured to mesh with the plurality of planet gears; and
a friction clutch configured to inhibit rotation of the ring gear when a torque being transferred from the engine to the generator is less than a threshold value.

19. The power system of claim 18, wherein:
the friction clutch is further configured to allow rotation of the ring gear when the torque of the power system is greater than the threshold value; and
allowing rotation of the ring gear reduces an amount of torque transmitted by the power system.

20. The power system of claim 18, furthering including a housing configured to at least partially enclose the flywheel, the planet carrier, the damper, the sun gear, the ring gear, and the friction clutch, wherein the friction clutch is configured to inhibit rotation of the ring gear by locking the ring gear to the housing.
